(19) United States
(12) Patent Application Publication
(10) Pub. No.: US 2016/0021696 A1
(43) Pub. Date: Jan. 21, 2016

(54) METHOD OF REPORTING LINK FAILURE

(71) Applicant: ACER INCORPORATED, New Taipei City (TW)

(72) Inventor: Ming-Dao Chuang, New Taipei City (TW)

(21) Appl. No.: 14/869,978

(22) Filed: Sep. 29, 2015

Related U.S. Application Data
(63) Continuation of application No. 13/757,858, filed on Feb. 4, 2013.
(60) Provisional application No. 61/602,087, filed on Feb. 23, 2012.

(30) Foreign Application Priority Data
Mar. 27, 2012 (TW) 101110545

(51) Int. Cl. H04W 76/02

(52) U.S. Cl. CPC H04W 76/027

(57) ABSTRACT

If a new link is established between a user equipment and a serving base station after a previous link failure, the user equipment is configured to report information associated with the previous link failure, including UE mobility information during the previous link, information related to transmitting/receiving the RRC connection reconfiguration, or information related to radio link failure. The serving base station is configured to perform mobility optimization in the minimization of drive test accordingly for improving handover success rate and overall network efficiency.

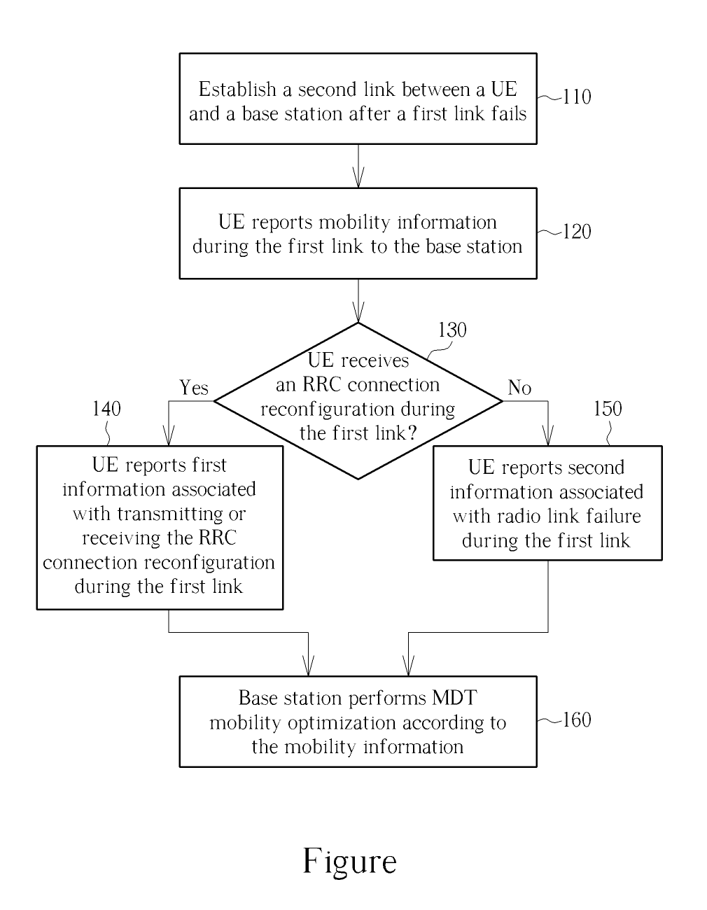

### CROSS REFERENCE TO RELATED APPLICATIONS

This application is a continuation application of U.S. patent application Ser. No. 13/757,858 filed on Feb. 4, 2013, which claims priority of U.S. Patent Application No. 61/602,087 filed on Feb. 23, 2012.

### BACKGROUND OF THE INVENTION

1. Field of the Invention

The present invention is related to a method of reporting link failure, and more particularly, to a method of reporting link failure for performing mobility optimization in minimization of drive tests.

2. Description of the Prior Art

The 3rd Generation Partnership Project (3GPP) has developed a universal mobile telecommunications system (UMTS) which adopts a wideband code division multiple access (WCDMA) technology capable of providing high frequency spectrum utilization, universal coverage, and high-speed/quality multimedia data transmission. In the UMTS, a radio access network known as a universal terrestrial radio access network (UTRAN) includes multiple Node-Bs (NBs) for communicating with multiple user equipment (UE). Furthermore, a long-term evolution (LTE) system is now being developed by the 3GPP in order to further improve performance of the UMTS to satisfy users' increasing needs. The LTE system includes a new radio interface and radio network architecture which provides a high data rate, low latency, packet optimization, and improved system capacity and coverage. In the LTE system, a radio access network known as an evolved UTRAN (E-UTRAN) includes multiple evolved NBs (eNBs) for communicating with multiple UEs and a core network which includes a mobility management entity (MME), a serving gateway and other devices for NAS (Non Access Stratum) control.

NBs of the wireless communication system must be deployed properly in order to provide seamless, high quality and large signal coverage without experiencing call drops or signal degradation. However, planning and optimizing the deployment of the NBs are based on signal quality measurements which may be time- and effort consuming for an operator of the wireless communication system. Common methods of performing the measurements include measuring the signal strength or quality at different time and geographical locations of interest. Therefore, it is more economical for a UE of the wireless communication to perform the measurements and send the measurement report to an NB. Based on the measurement reports received from multiple UEs, the deployment of the NBs may be planned and optimized accordingly without spending many human and material resources. The minimization of drive test (MDT) has been proposed in current 3GPP specifications in order to perform coverage optimization, mobility optimization, capacity optimization and Quality of Service (QoS) verification. However, the MDT mobility optimization in LTE systems has not been addressed.

### SUMMARY OF THE INVENTION

The present invention provides a method of reporting link failure. The method includes establishing a second link between a user equipment and a target base station after a first link between the user equipment and a serving base station fails; the user equipment reporting first information associated with a radio link failure which occurs during the first link to the target base station after establishing the second link, wherein the first information includes a start time of a timer defined in a corresponding 3rd Generation Partnership Project specification, an expire time of the timer, a media access control (MAC) problem, or a radio link control (RLC) problem.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The FIGURE is a flowchart illustrating a method of reporting link failure according to an embodiment of the present invention.

### DETAILED DESCRIPTION

Handover is a procedure during which the management right of a moving UE is transferred from a current serving base station to a nearby target base station for maintaining data or communication link. According to 3GPP specifications (such as TS 36.300, TS 36.304, TS 36.320, TS 36.331, or TS 36.805), the handover procedure includes 4 major steps:
(1) UE transmits measurement report, based on which the serving base station determines whether the handover procedure should be initiated.
(2) UE receives radio resource control (RRC) connection reconfiguration from the target base station for performing the handover procedure.
(3) UE performs a random access channel (RACH) procedure to acquire uplink synchronization with the target base station.
(4) UE sends an “RRC CONNECTION RECONFIGURATION COMPLETE” message after completing the uplink synchronization with the target base station.

For a UE and a serving base station in a wireless communication system, the present invention provides a method of reporting link failure for performing MDT mobility optimization. In the present invention, the wireless communication system may be a UMTS or an LTE system which includes a network and multiple UEs in a simplified embodiment. In the UMTS, the network may be a UTRAN including a plurality of NBs. In the LTE system, the network may be an E-UTRAN including a plurality of eNBs. The UE may be a mobile phone, a laptop computer, a tablet computer, an e-book or any portable computer system. However, the above examples are merely embodiments and do not limit the scope of the present invention.

The FIGURE is a flowchart illustrating a method of reporting link failure. The flowchart in the FIGURE includes the following steps:

Step 110: establish a second link between a UE and a base station after a first link fails; execute step 120.

Step 120: the UE reports mobility information during the first link to the base station; execute step 130.

Step 130: determine if the UE receives an RRC connection reconfiguration during the first link; if yes, execute step 140; if no, execute step 150.

Step 140: the UE reports first information associated with transmitting or receiving the RRC connection reconfiguration during the first link; execute step 160.

Step 150: the UE reports second information associated with radio link failure (RLF) during the first link; execute step 160.

Step 160: the base station performs MDT mobility optimization according to the mobility information.

In step 110, the first link may fail due to handover failure or radio link failure. During the handover procedure, the target base station may send the RRC connection reconfiguration to the UE using over-the-air (OTA) technology. If the target base station sends the RRC connection reconfiguration too late (which may happen when the UE changes its location or speed), the UE may not be able to complete RACH procedure in time for acquiring uplink synchronization with the target base station, thereby causing handover failure. On the other hand, if the variation in background environment causes signal interferences, the UE may not be able to receive the RRC connection reconfiguration from the serving base station, thereby causing radio link failure. Therefore, in the present invention, the second link may be re-established between the UE and the serving base station after the first link fails.

In step 120, after establishing the second link, the UE is configured to report the mobility information during the first link. In the embodiment of the present invention, the mobility information may include an UE mobility state, a change in the UE mobility state, or a UE speed when the UE mobility state changes, which are measured during the first link.

In the embodiment when the mobility information includes the UE mobility state, the UE is configured to measure reference signal received power (RSRP) or reference signal received quality (RSRQ) of the serving base station and the target base station. Based on how many times cell re-selection occurs during a predetermined period, the UE may determine whether the mobility information indicates a high-mobility state, a medium-mobility state or a low-mobility state.

In the embodiment when the mobility information includes the change in the UE mobility state, the UE is configured to measure its location or timing change during the first link. For example, the UE may measure its location change during the first link using a standalone global positioning system GPS, a standalone global navigation satellite system (GNSS), an assisted GPS, an assisted GNSS, a location services (LCS) orientation, or a secure user plane location (SUPL) orientation. Or, the UE may acquire its timing change by measuring transmission times of a single-frequency network (SFN) or an orthogonal frequency-division multiplexing (OFDM) during the first link.

In the embodiment when the mobility information includes the UE speed, the UE may measure its speed during the first link using a standalone GPS, a standalone GNSS, an assisted GPS, an assisted GNSS, an LCS orientation, or an SUPL orientation.

In step 130, the UE is configured to determine whether an RRC connection reconfiguration is received during the first link. If the UE has received the RRC connection reconfiguration during the first link, it can be determined that handover failure causes the first link to fail, and step 140 is then executed. If the UE has not received any RRC connection reconfiguration during the first link, it can be determined that radio link failure causes the first link to fail, and step 150 is then executed.

According to corresponding 3GPP specifications (such as TS 36.300, TS 36.304, TS 36.320, TS 36.331, or TS 36.805), the RRC connection reconfiguration includes mobility control information required for performing the handover procedure, such as cell radio network temporary identifier (C-RNTI), security algorithm identifier, system information block (SIB) parameter of the target base station, and RACH preamble parameter of the target base station. The target base station is configured to transmit the RRC connection reconfiguration using a specific RACH power. The UE is configured to activate timer T304 upon receiving the RRC connection reconfiguration and stop timer T304 after acquiring uplink synchronization with the target base station

In step 140, the UE is configured to report the first information associated with transmitting or receiving the RRC connection reconfiguration during the first link. In the embodiment of the present invention, the UE may report the start/expire time of timer T304, the location or speed of the UE when timer T304 starts/expires, or the maximum RACH power used to transmit the RRC connection reconfiguration. However, the above embodiments are merely for illustrative purposes and do not limit the scope of the present invention.

According to corresponding 3GPP specifications (such as TS 36.300, TS 36.304, TS 36.320, TS 36.331, or TS 36.805), a wireless transmit/receive unit (WTRU) is configured to monitor the link between the UE and the serving base station and perform a recovery procedure when encountering radio link failure. The WTRU may monitor a specific transmission carrier and detect in-sync/out-of-sync indications. After receiving the out-of-sync indication for a predetermined number of times, timer T310 may be activated. If the UE does not receive the in-sync indication over a predetermined number of times before timer T310 expires, it can thus be determined that the radio link has failed. On the other hand, when the media access control (MAC) reports random access error or the radio link control (RLC) informs that the maximum retransmission limit has been reached, it can also be determined that the radio link has failed.

In step 150, the UE is configured to report the second information associated with radio link failure during the first link. In the embodiment of the present invention, the UE may report the start/expire time of timer T310, MAC problem or RLC problem. However, the above embodiments are merely for illustrative purposes and do not limit the scope of the present invention.

In step 160, the serving base station is configured to perform MDT mobility optimization according to the mobility information, such as adjusting network parameters for regions with insufficient signal coverage or adjusting the transmitting time of the RRC connection reconfiguration according to different UE mobility states.

In the present invention, if a new link can be re-established between the UE and the serving base station after a previous link fails, the UE is configured to report information associated with the previous link failure to the serving base station. The reported information may include UE mobility information during the previous link, data associated with transmitting/receiving the RRC connection reconfiguration or data associated with radio link failure. The serving base station may perform MDT mobility optimization accordingly, thereby improving handover success rate and overall network efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reporting link failure, comprising:
establishing a second link between a user equipment (UE) and a target base station after a first link between the user equipment and a serving base station fails;
the user equipment reporting first information associated with a radio link failure (RLF) which occurs during the first link to the target base station after establishing the second link, wherein the first information includes a start time of a timer defined in a corresponding 3rd Generation Partnership Project specification, an expire time of the timer, a media access control (MAC) problem, or a radio link control (RLC) problem.

2. The method of claim 1, further comprising:
the base station performing a minimization of drive test (MDT) mobility optimization according to the first information.

3. The method of claim 1, further comprising:
when determining that a radio resource control (RRC) connection reconfiguration is not received during the first link, the user equipment reporting the first information to the target base station.

4. The method of claim 1, wherein the target base station is the same as the serving base station.

5. The method of claim 1, further comprising:
measuring mobility information during the first link, wherein the mobility information includes at least a user equipment mobility state, a change in the user equipment mobility state, or a user equipment mobility speed when the user equipment mobility state changes;
retaining the mobility information measured during the first link regardless of whether the user equipment has encountered a coverage problem for a predetermined period of time during the first link; and
the base station performing a minimization of drive test (MDT) mobility optimization according to the first information and the mobility information.

6. The method of claim 5, further comprising:
measuring a reference signal received power (RSRP) or a reference signal received quality (RSRQ) of the serving base station and the target base station during the first link; and
determining that the mobility information indicates a high-mobility state, a medium-mobility state or a low-mobility state according to how many times a cell re-selection occurs during a predetermined period.

7. The method of claim 5, further comprising:
providing the change in the user equipment mobility state by measuring a location change of the user equipment during the first link using a standalone global positioning system GPS, a standalone global navigation satellite system (GNSS), an assisted GPS, an assisted GNSS, a location services (LCS) orientation, or a secure user plane location (SUPL) orientation.

8. The method of claim 5, further comprising:
providing the change in the user equipment mobility state based on a timing change of the user equipment which is acquired by measuring transmission times of a single-frequency network (SFN) or an orthogonal frequency-division multiplexing (OFDM) during the first link.

9. The method of claim 5, further comprising:
acquiring the user equipment speed using a standalone GPS, a standalone GNSS, an assisted GPS, an assisted GNSS, an LCS orientation, or an SUPL orientation.

10. The method of claim 1, further comprising:
when determining that a radio resource control (RRC) connection reconfiguration is received during the first link, the user equipment reporting second information associated with transmitting or receiving the RRC connection reconfiguration during the first link; and
the base station performing a minimization of drive test (MDT) mobility optimization according to the first information and the second information.

11. The method of claim 10, wherein the second information includes:
a start time of a timer T304 defined in a corresponding 3rd Generation Partnership Project specification;
an expire time of the timer T304;
a location or a speed of the user equipment when the timer T304 starts;
a location or a speed of the user equipment when the timer T304 expires; or
a maximum random access channel (RACH) power used to transmit the RRC connection reconfiguration.
